(19) United States
(12) Patent Application Publication
(10) Pub. No.: US 2015/0056598 A1
(43) Pub. Date: Feb. 26, 2015

(54) SYSTEM AND METHOD FOR DISPLAYING USER-SPECIFIC CONTENT ON AN E-LEARNING PLATFORM

(71) Applicant: LoudCloud Systems Inc., Dallas, TX (US)

(72) Inventors: Manoj Kutty, Dallas, TX (US); Anil Vishwanath Sonkar, Andheri (IN); Dinesh Madhavan Warrier, Mumbai (IN); Bharat Ranjan Kavuluri, Hyderabad (IN); Aniruddha Dutta Chowdhury, Kolkata (IN); Ramesh Babu Chowdaiah Tatimatla, Guntur (IN)

(73) Assignee: LoudCloud Systems Inc., Dallas, TX (US)

(21) Appl. No.: 13/973,787

(22) Filed: Aug. 22, 2013

(51) Int. Cl. G09B 7/08

(52) U.S. Cl. CPC G09B 7/08
USPC 434/362

(57) ABSTRACT

The present disclosure described herein, generally relates to a system and method for displaying user-specific content on an online learning platform. In one aspect, a method and system are disclosed for displaying user-specific content retrieved from an internet to the user, based on user's requirement. Based on the interaction of the user with the learning platform, a user-profile may be generated and further categorized into a pre-defined learning category. Along with the user-profile, the system may be also configured to generate a profile of content fetched from the online library of the learning platform on basis of pre-defined parameters. From the content profiled, phrases may be extracted for generating search strings. These search strings may be further used to perform an automated search over the internet to retrieve the user-specific content. Further, the user-specific content may be also profiled on basis of the pre-defined parameters. The user-specific content may be evaluated against the content fetched to evaluate and assign a score to the user-specific content. Based on the score assigned, the user-specific content may be displayed to the user.

### TECHNICAL FIELD

The present disclosure described herein, generally relates to a system and method for displaying user-specific content on an online learning platform.

### BACKGROUND

Electronic learning has its own importance and significance in the field of education system. Its availability and coverage has increased in the last several decades throughout the globe. Today, universities, schools and other educational institutes are adapting this e-learning through e-learning platforms to provide a superior and technically advanced teaching approach. These e-learning platforms are adaptive in nature, i.e., they follow the teaching approach based on the learning style of the user. The user may be a student, any professional, a scholar or any individual seeking for being educated by enrolling themselves through these e-learning platforms.

These e-learning platforms generally consist of a pre-defined set of learning contents stored in their databases based on the pre-determined decision tree that may be already hard-coded into the learning system. These learning contents are specific for a particular category of students based on their learning style. Further, the learning contents are also static in nature and the same set of contents are repeatedly presented for teaching the students falling under the specific category. These learning platforms are not capable of automatically updating the learning contents stored in their memory.

### SUMMARY

This summary is provided to introduce concepts related to systems and methods for displaying user-specific content to at least one user interacting with a learning platform and the concepts are further described below in the detailed description. This summary is not intended to identify essential features of the claimed subject matter nor is it intended for use in determining or limiting the scope of the claimed subject matter.

In one implementation, a system for displaying user-specific content to at least one user interacting with a learning platform embodied thereon is disclosed. The system may comprise a processor and a memory coupled to the processor for executing a plurality of modules present in the memory. The plurality of modules may comprise a user-interaction module, a user-profiling module, a display module, a content-fetching module, a content-profiling module, a phrase extraction module, a search module, an evaluating module and a score assigning module. The user-interaction module may be configured to capture interaction-data of the at least one user engaged with one or more learning activities over the learning platform. The user-profiling module may be configured to: derive a user-profile of the at least one user based on the interaction-data; and to categorize the user-profile derived into at least one of a pre-defined learning category. In order to generate a user-specific content, the content-fetching module may be configured to fetch content from an online library stored on the learning platform. After fetching the content, the content-profiling module may be configured to profile the content fetched from the online library on basis of pre-defined parameters. Further, the phrase extraction module may be configured to extract phrases from the content profiled to generate one or more search-string. Thereafter, the search module may be configured to perform an automated search over an internet using the one or more search-string to retrieve the user-specific content. After retrieving the user-specific content, the content-profiling module may be further configured to generate a profile of the user-specific content retrieved from the internet on the basis of the pre-defined parameters. The evaluating module may be configured to evaluate the profile of the user-specific content in relative to the profile of the content in order to match the user-profile categorized with the at least one user-specific content. Further, the score assigning module may be configured to assign a score to the user-specific content, based on the evaluation of the profile of the at least one user-specific content. After assigning the score, the display module may be configured to display the user-specific content to at least one user in the order of assigned score.

In another implementation, a method for displaying user-specific content to at least one user interacting with a learning platform is disclosed. An interaction-data of the at least one user engaged with one or more learning activities over the learning platform may be captured. Based on the interaction-data captured, a user-profile may be derived for the at least one user. The user-profile derived may be further categorized into at least one of a pre-defined learning category. The user-specific content may be displayed to the at least one user after the user-specific content is generated. To generate the user-specific content, content may be fetched from an online library stored on the learning platform. The content fetched from the online library may be further profiled on a basis of pre-defined parameters. After profiling the content, phrases may be extracted from the content to generate one or more search-string. Based on the one or more search string generated, an automated search may be performed over an internet for retrieving the user-specific content. As similar to the content fetched from the online library is profiled, the user-specific content retrieved from the internet may be also profiled on basis of the pre-defined parameters. After profiling the user-specific content, the profile of the user-specific content may be evaluated in relative to the profile of the content in order to match the user-profile categorized with the at least one user-specific content. Based on the evaluation of the profile of the at least one user-specific content, a score may be assigned to the user-specific content. The user-specific content may be then displayed to the at least one user in the order of assigned score.

In yet another implementation, a computer program product having embodied thereon a computer program for displaying user-specific content to at least one user over a learning platform is disclosed. The computer program product may comprise a program code for capturing interaction-data of the at least one user engaged with one or more learning activities over the learning platform. Based on the interaction-data captured, a program code may be configured for deriving a user-profile of the at least one user. Further, a program code may be configured for categorizing the user-profile derived into at least one of a pre-defined learning category. Thereafter, a program code may be configured for displaying the user-specific content to the at least one user after the user-specific content is generated. To generate the user-specific content, a program code may be configured for fetching content from an online library stored on the learning platform. Further, a program code may be configured for generating a profile for the content fetched on basis of pre-defined parameters. Further, a program code may be configured for extracting phrases from the content profiled to generate one or more search-string. A program code may be configured for performing an automated search over an internet to retrieve the user-specific content based on the search string generated. Once the user-specific content is retrieved, a program code may be configured for generating a profile for the user-specific content on basis of the pre-defined parameters. Thereafter, a program code may be configured for evaluating the profile of the at least one user-specific content in relative to the profile of the content in order to match the user-profile categorized with the at least one user-specific content. Further, a program code may be configured to assign a score to the user-specific content based on the evaluation of the profile of the user-specific content. Thus, on the basis of the score assigned, a program code may be configured to display the user-specific content to the at least one user.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for displaying user-specific content over a learning platform embodied thereon is shown, in accordance with an embodiment of the present disclosure.

FIG. 2 illustrates the system, in accordance with an embodiment of the present disclosure.

FIG. 3 illustrates a detailed working of the system, in accordance with an embodiment of the present disclosure.

FIG. 4 illustrates a method for displaying user-specific content over a learning platform, in accordance with an embodiment of the present disclosure.

### DETAILED DESCRIPTION

Systems and methods for displaying user-specific content to at least one user interacting with a learning platform are described. The at least one user may be a student, a learner, a course-seeker, a trainee, a scholar or any user interacting with the learning platform. Hereinafter, “at least one user” is referred to as “user”. During the interaction with the learning platform, user may be engaged in different types of activities, more particularly, learning activities. The learning activities may include writing in a forum, attempting an assignment, solving a quiz or any other activity which may be performed by the user on the system. Based on the interaction of the user with the learning activities, an interaction-data corresponding to each interaction may be captured and stored in a database of the system. On the basis of interaction-data captured for the user, the system may be configured for deriving a user-profile. The user-profile may be derived in order to categorize the user into a pre-defined learning category. The pre-defined learning category may define the learning style/learning capability of the user. Based on the learning style of the user, the system may be enabled to continuously update the existing content, more specifically learning content to adapt a better teaching approach for the user.

The system may be further configured to generate the user-specific content for the user. In order to generate such user-specific content, the system fetches the content from an online library stored on the learning platform. The online library may be a collection of several learning materials in a form of text, web-link, audio, video or combination thereof. After fetching the content, a profile may be generated for the content on a basis of pre-defined parameters. The pre-defined parameters in which the content is profiled may be a length of the content i.e., “content length”, “language complexity” of the content, “interactivity level” of the content and “conceptual level” of the content. The profile of the content may be used as a base for evaluating the user-specific content. From the content profiled, phrases may be extracted for generating one or more search-string. The one or more search-string generated may be further used for performing an automated search on the internet in order to retrieve the user-specific content.

The user-specific content retrieved from the internet may also be profiled on the basis of the pre-defined parameters like length of the user-specific content i.e., “user-specific content length”, “language complexity” of the user-specific content, “interactivity level” of the user-specific content and “conceptual level” of the user-specific content. Thereafter, the profile of the user-specific content may be evaluated in relative to the profile of the content fetched from the online library. Based on the evaluation, the user-profile categorized for the user may be matched with the user-specific content. Here, the system may decide which user-specific content should be displayed to which user interacting with the learning platform and in which order. Further, based on the evaluation, a score may be assigned to the profile of the user-specific content. Thus, in order of the score assigned to the user-specific content, it may be displayed or displayed to the user.

While aspects of described system and method for displaying user-specific content to the user interacting with a learning platform may be implemented in any number of different computing systems, environments, and/or configurations, the embodiments are described in the context of the following exemplary system.

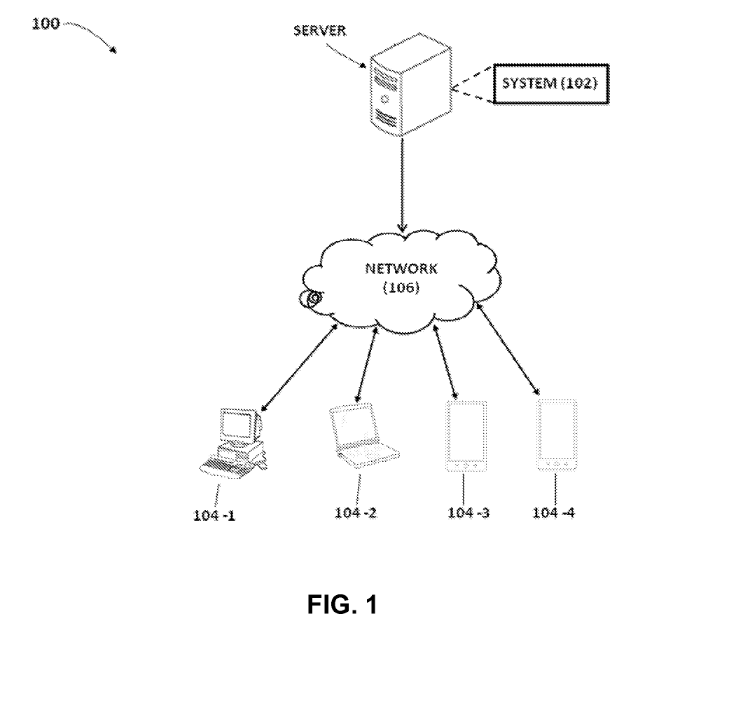

Referring now to FIG. 1, a network implementation 100 of a system 102 for displaying user-specific content to the user interacting with a learning platform is illustrated, in accordance with an embodiment of the present disclosure. In one embodiment, the system 102 captures the user's interaction-data for profiling the user and generating user-profile. The user-profile generated may be further categorized into a pre-defined learning category. In one embodiment, along with the user-profile generation, content fetched from the online library of the learning platform may be also profiled. From the content profiled, phrases may be extracted and based on the phrases one or more search-string may be formed/generated. In one embodiment, the system 102 performs an automated search over an internet using the one or more search-string formed in order to retrieve the user-specific content. Further, the system 102 also profiles the user-specific content and thereafter evaluates the profile of the user-specific content against the profile of the content in order to match the user-profile with the user-specific content. Based on the evaluation, the system 102 assigns a score to the user-specific content. Thus, in accordance of order of the score assigned, the user-specific content may be displayed to the user.

Although the present disclosure is explained considering that the system 102 is implemented as learning platform on a server, it is to be understood that the system 102 may also be implemented in a variety of computing systems, such as a laptop computer, a desktop computer, a notebook, a workstation, a mainframe computer, a server, a network server, and the like. It will be understood that the system 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 may be communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

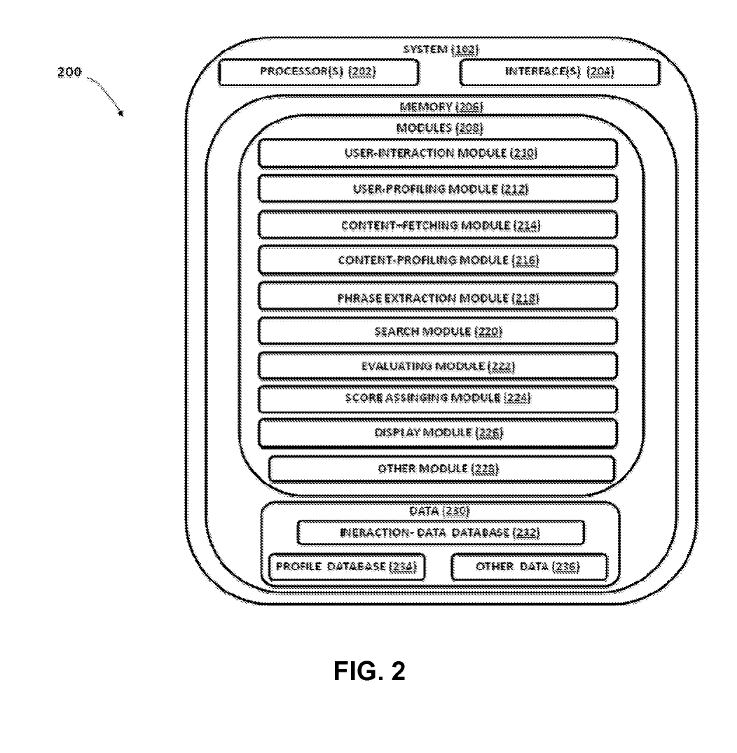

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions stored in the memory 206.

The I/O interface 204 may include a variety of software and hardware interfaces, for example, a web interface, a graphical user interface, and the like. According to the embodiments of the present disclosure, the I/O interface 204 may be an e-learning platform embodied on the system 102. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, a compact disks (CDs), digital versatile disc or digital video disc (DVDs) and magnetic tapes or any other storage media. The memory 206 may include modules 208 and data 230.

The modules 208 may include routines, programs, objects, components, data structures, etc., which facilitate a processor to execute particular tasks, or which implement particular data types. In one implementation, the modules 208 may include a user-interaction module 210, a user-profiling module 212, a content-fetching module 214, a content-profiling module 216, a phrase extraction module 218, a search module 220, an evaluating module 222, a score assigning module 224, a display module 226 and other modules 228. The other modules 228 may include programs or coded instructions that supplement applications and functions of the system 102.

The data 230, amongst other things, may serve as a repository for storing data processed, received, and generated by one or more of the modules 208. The data 230 may also include an interaction-data database 232, a profile database 234 and other data 236. The other data 236 may include data generated as a result of the execution of one or more modules in the other module 228.

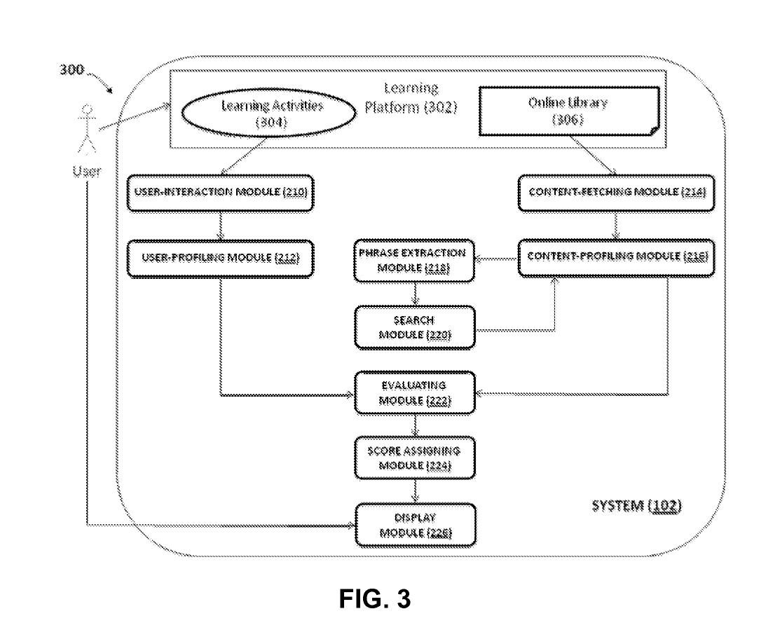

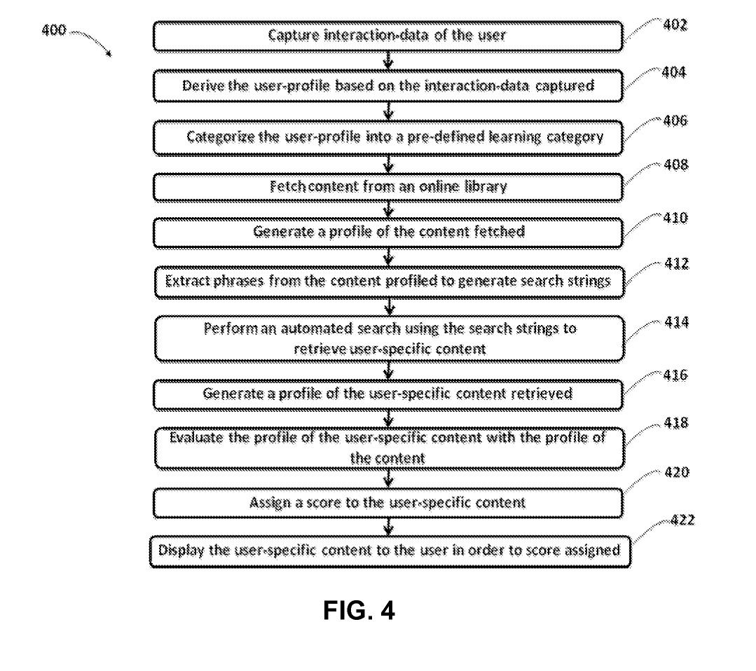

In one implementation, at first, a user may use the client device 104 to access the system 102 via the I/O interface 204. The user may register them using the I/O interface 204 in order to use the system 102. The working of the system 102 is explained in detail in FIGS. 3 and 4 explained below. The system 102 may be used for displaying user-specific content to the user. In order to display the user-specific content, the system 102 may generate the profiles of users and the user-specific content retrieved from the internet. The internet may be an online or offline network according the embodiments of the present disclosure. After generating the profiles, the system 102 may match the profiles in order to display the user-specific content to the intended user interacting with the learning platform.

Referring to FIG. 3, a detailed working of the system 102 is illustrated, in accordance with an embodiment of the present disclosure. In one embodiment, a system 102 including a learning platform 302 may facilitate with providing learning materials to the user. These learning materials may be retrieved from the learning platform 302 or may also be retrieved from different online and offline sources, wherein the learning materials retrieved may be presented to the user. The learning materials presented to the user may be specific to the user's requirement or user's learning capability. During the interaction with the learning platform 302, the user may engage with one or more learning activities 304. Hereinafter, the “one or more learning activities” may be referred to as “learning activities”. In embodiments of the present disclosure, the learning activities 304 may be at least one of a writing a forum, attempting an assignment, solving a quiz or any other activities performed by the user over the learning platform 302. The other activities may include highlighting the learning materials from the learning platform 302, appending web-links, creating notes in a form of text, images, videos or combination thereof. While the interaction commences, one of a module of the system 102, user-interaction module 210 may be configured to capture the user's interaction as interaction-data. In embodiments of the present disclosure, the interaction-data of the user may be captured while writing the forum, while attempting the assignment, while solving the quiz or while interacting and performing with the any other activities over the learning platform 302. The interaction-data may also comprise of data captured for average time spent over the learning material, number of past classes visited by the user, average time-difference between the quiz start and attempt, average time-difference between forum topic start and post, time spent on chat, average time spent on calendar, average time spent on a particular course from the learning material. Further, the interaction-data captured for above described scenarios may be stored in interaction-data database 232 of the system 102 for analysis.

Based on the interaction-data captured and stored, a user-profiling module 212 may be configured to derive a user-profile for the user. After profiling the user, the user-profiling module 212 may be also configured to categorize the user-profile into at least one of a pre-defined learning category. Hereinafter the “at least one of a pre-defined learning category” may be referred to as “learning categories”. In embodiments of the present disclosure, the learning categories may be an activist, theorist, reflector and pragmatist or any other learning category which may be defined for categorizing the user-profile. The learning categories may be defined by using “Honey-Mumford model”. In some implementations, the terms or definitions used in the description may be defined in an exemplary manner as follows:

An “activist” may be that category of user which prefers the challenges of new experiences, involvement with others, assimilation and role-playing. This category may like anything new, problem solving, and small group discussions.

A “theorist” may be that category of user which prefers to think problems through in a step-by-step manner. This category may like lectures, analogies, case studies, learning-models, and readings. For this category, talking with experts may be normally not helpful.

A “reflector” may be that category of the user who prefers to learn from activities that allow them to watch, think, and review. This category may likes to use journals and brainstorming. For this category, lectures may be helpful if they provide expert explanations and analysis.

A “pragmatist” pragmatist may be that category which prefers to apply new learning to actual practice to see if they work. This category may like laboratories, field work, and observations. Further, this category may also like feedback, coaching, and obvious links between the task-on-hand and a problem.

Along with the user-profile generation and categorization, content from online library 306 of the learning platform 302 may be also profiled by the system 102. In order to profile the content, a content-fetching module 214 may be configured to fetch the content from an online library 306 stored on the learning platform 302. In embodiments of the present disclosure, the online library 306 may include content representing the learning materials in a form of text, audio, video or combination thereof. After the content is fetched, a content-profiling module 216 may be configured to profile the content fetched from the online library 306 on basis of pre-defined parameters. According to the pre-defined parameters, the content fetched from the online library 306 may be profiled which may be length of the content i.e., “content length”, “language complexity” of the content, “interactivity level” of the content and “conceptual level” of the content. The profile of the content may be used as a basis for evaluating a user-specific content which is to be displayed to the user. Further, the content-profile may be stored in profile database 234 of the system 102.

Thereafter, a phrase extraction module 218 may be configured to extract phrases from the content profiled to generate one or more search-string. In embodiments of the present disclosure, the phrase extraction may involve “Part-of-speech” (POS) tagging, wherein the POS tagging may be labeling each word from the content profiled in a particular part a speech, based on its definition and its context in the content. For POS tagging, a viterbi tagger may be used. Further, another step may be involved which may be called as “phrase formation”. The “phrase formation” may be implemented by using n-gram extraction technique, wherein the n-gram extraction gives phrases from every sentence between pre-set limits. After extracting the phrases by implementing the above discussed techniques, the phrases may be ranked in order of their importance. The phrases extracted may be stored in the profile database 234 of the system 102.

The purpose of extracting the phrases may be to form or generate the one or more string. Hereinafter the “one or more search string” may be referred to as “search strings”. The search strings may be formed on the basis of the phrase extracted and ranked as well as from context-information such as course, class and topic and other details in order to bias the search results towards user's requirements.

Based on the search strings generated, a search module 220 may be configured to perform an automated search over an internet or web to retrieve the user-specific content. In embodiments of the present disclosure, the internet may be an online network, computer network or any other offline and online sources.

After the user-specific content being retrieved, the content-profiling module 216 may be further configured to generate a profile of the user-specific content on the basis of the pre-defined parameters. The pre-defined parameters based on which the user-specific content is profiled may be length of the user-specific content i.e., “user-specific content length”, “language complexity” of the user-specific content, “interactivity level” of the user-specific content and “conceptual level” of the user-specific content. Thus, the content-profiling module 216 may be configured for generating the profile of both, the content fetched from the online library 306 and the user-specific content retrieved from the internet.

Thereafter, the evaluating module 222 may be configured to evaluate the profile of the user-specific content in relative to the profile of the content in order to judge the comprehensibility and the quality of the user-specific content retrieved. Based on the evaluation, the user-profile of the user categorized in the pre-defined category may be matched with the user-specific content.

On the basis of the evaluation process, a score assigning module 224 may be configured to assign a score to the user-specific content. The score assigned to the user-specific content defines the quality and the comprehensibility of the user-specific content. After assigning the score, the display module 226 may be configured to display the user-specific content to the user in the order of the assigned score. Thus, the user interacting with the learning platform 302 may be displayed with the user-specific content according to the user's requirement or user's learning capability.

Referring now to FIG. 4, a method 400 for displaying user-specific content to the user interacting with a learning platform 302 is shown, in accordance with an embodiment of the present disclosure. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions may be performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described system 102.

At block 402, interaction-data of the user may be captured while the user is engaged in interacting with learning activities 304 over the learning platform 302. In embodiments of the present disclosure, the learning activities may be at least one of a writing a forum, attempting an assignment, solving a quiz or any other activities performed by the user over the learning platform 302.

At block 404, based on the interaction-data captured, profile of the user i.e., “user-profile” may be derived.

At block 406, once the user-profile is derived, categorization of the user-profile may be done into pre-defined learning categories. The categorization of the user-profile may be done in order to classify the user based on their learning capability and learning requirement. Further, the categorization of the user-profile may help the system 102 to decide upon which user-specific content to be displayed to which user.

At block 408, along with the profiling and categorization of the user-profile, content from an online library 306 may be fetched, wherein the online library 306 may be stored on the learning platform 302.

At block 410, profile for the content fetched from the online library 306 may be generated i.e., “content-profile on basis of pre-defined parameters. In embodiments of the present disclosure, the pre-defined parameters may be length of the content i.e., “content length”, “language complexity” of the content, “interactivity level” of the content and “conceptual level” of the content.

At block 412, after generating the content-profile, phrases may be extracted from the content profiled to further generate search strings. The phrases extracted may be ranked in order of their importance.

At block 414, based on the search strings generated, an automated search may be performed over an internet to retrieve the user-specific content.

At block 416, as similar to the profiling done for the content fetched from the online library 306 at the block 410, profile of the user-specific content may be also generated on the basis of the pre-defined parameters. In embodiments of the present disclosure, the pre-defined parameters may be length of the user-specific content i.e., “user-specific content length”, “language complexity” of the user-specific content, “interactivity level” of the user-specific content and “conceptual level” of the user-specific content.

At block 418, the profile of the user-specific content retrieved from the internet may be evaluated in relative to the profile of the content fetched from the online library 306 of the learning platform 302. The evaluation may be done in order to match the user-profile categorized at the block 406 with the user-specific content retrieved and profiled.

At block 420, based on the evaluation done, a score may be assigned to the user-specific content. The score assigned to the user-specific content defines the quality and the comprehensibility of the user-specific content.

At block 422, the user-specific content may be displayed to the user in order of the score assigned.

Although implementations for methods and systems for displaying the user-specific content to at least one user interacting with a learning platform 302 have been described in language specific to structural features and/or methods, it is to be understood that the appended claims are not necessarily limited to the specific features or methods described. Rather, the specific features and methods are disclosed as examples of implementations for displaying the user-specific content.

We claim:

1. A method for displaying user-specific content to at least one user interacting with a learning platform, the method comprising:
capturing interaction-data of at least one user engaged with one or more learning activities over a learning platform;
deriving a user-profile of the at least one user based on the interaction-data captured;
categorizing the user-profile derived into at least one of a pre-defined learning category;
generating, by a processor, user-specific content to the at least one user, wherein the user-specific content is generated by:
fetching content from an online library stored on the learning platform;
generating a profile for the content fetched from the online library on basis of pre-defined parameters;
extracting phrases from the content profiled to generate one or more search-string;
performing an automated search over an internet using the one or more search-string to retrieve the user-specific content;
generating a profile for the user-specific content retrieved on basis of the predefined parameters;
evaluating the profile of the at least one user-specific content in relative to the profile of the content in order to match the user-profile categorized with the at least one user-specific content;
assigning a score to the user-specific content, based on the evaluation of the profile of the at least one user-specific content; and
displaying the user-specific content to the at least one user in the order of assigned score.

2. The method of claim 1, wherein the learning activities comprises at least one of a writing a forum, attempting an assignment or solving a quiz.

3. The method of claim 1, wherein the interaction-data is captured while writing the forum, while attempting the assignment, while solving the quiz.

4. The method of claim 1, wherein the pre-defined learning category comprises at least one of an activist, theorist, reflector and pragmatist.

5. The method of claim 1, wherein the pre-defined parameters comprise at least one of length of the content, language complexity of the content, interactivity level of the content and conceptual level of the content.

6. A system for displaying user-specific content to at least one user interacting with a learning platform, comprising:
a processor; and
a memory coupled to the processor, wherein the processor is capable of executing a plurality of modules stored in the memory, the plurality of modules comprising:
a user-interaction module configured to capture interaction-data of the at least one user engaged with one or more learning activities over a learning platform;
a user-profiling module configured to:
derive a user-profile of the at least one user based on the interaction-data; and
categorize the user-profile derived into at least one of a pre-defined learning category;
a content-fetching module configured to fetch content from an online library stored on the learning platform;
a content-profiling module configured to profile the content fetched from the online library on basis of pre-defined parameters;
a phrase extraction module configured to extract phrases from the content profiled to generate one or more search-string;
a search module configured to perform an automated search over an internet using the one or more search-string to retrieve the user-specific content;
the content-profiling module further configured to generate a profile of the user-specific content retrieved from the internet on the basis of the pre-defined parameters;
an evaluating module configured to evaluate the profile of the user-specific content in relative to the profile of the content in order to match the user-profile categorized with the at least one user-specific content;
a score assigning module configured to assign a score to the user-specific content, based on the evaluation of the profile of the at least one user-specific content; and
a display module configured to display the user-specific content to the at least one user in the order of assigned score.

7. A computer program product having embodied thereon computer-executable instructions for displaying user-specific content to at least one user over a learning platform, the instructions comprising instructions for:
capturing interaction-data of the at least one user engaged with one or more learning activities over the learning platform;
deriving a user-profile of the at least one user based on the interaction-data captured;
categorizing the user-profile derived into at least one of a pre-defined learning category;
generating the user-specific content to the at least one user, wherein the user-specific content is generated by:
fetching content from an online library stored on the learning platform;
generating a profile for the content fetched from the online library on basis of pre-defined parameters;
extracting phrases from the content profiled to generate one or more search-string;
performing an automated search over an internet using the one or more search-string to retrieve the user-specific content;
generating a profile for the user-specific content retrieved on basis of the pre-defined parameters;
evaluating the profile of the at least one user-specific content in relative to the profile of the content in order to match the user-profile categorized with the at least one user-specific content;
assigning a score to the user-specific content, based on the evaluation of the profile of the at least one user-specific content; and
displaying the user-specific content to the at least one user in the order of assigned score.
